(19) United States
(12) Patent Application Publication
(10) Pub. No.: US 2004/0052166 A1
(43) Pub. Date: Mar. 18, 2004

(54) Command set for removable rewritable computer storage

(75) Inventors: Rob Theodrus Udink, Utrecht (NL); Robert Jochemsen, Eindhoven (NL); Maarten Peter Bodlaender, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/244,763

(22) Filed: Sep. 16, 2002

(51) Int. Cl. G11B 7/085

(52) U.S. Cl. 369/30.24; 369/53.37; 369/47.54

(57) ABSTRACT

A removable rewritable computer storage has a command set thereon for controlling a standard operation of a computer device. The command set includes a command having an activation field, a function field, a status field, and a results field. A command engine of the computer device reads the activation field to determine an activation condition upon which the command is to be executed. The command engine reads the function field and any associated arguments to determine the function of the command. The command engine reads the status field to determine an executable status of the command. The command engine writes the results of an execution of the command to the results field.

### TECHNICAL FIELD

The present invention generally relates to the field of computer storage. The present invention specifically relates to an interaction between removable rewritable computer storage (e.g., a compact disc, a digital video disc, etc.) and a computer device (e.g., a compact disc player and a digital video disc player).

### BACKGROUND AND SUMMARY OF THE INVENTION

Removable rewritable computer storage is typically referred to as “sneakernet” due to consumer usage of the mediums to exchange data between numerous computer devices. While such a content exchange via rewritable computer storage is on par with a content exchange via a network, rewritable computer storage prior to the present invention could not be utilized to control a standard operation of the computer device.

To overcome the inability of removable rewritable computer storage to control a standard operation of the computer device, the present invention provides a new and unique command set stored on a rewritable computer storage, and a new and unique command engine incorporated within a computer device. Various aspects of the present invention are novel, non-obvious, and provide various advantages. While the actual nature of the present invention covered herein can only be determined with reference to the claims appended hereto, certain features, which are characteristic of the embodiments disclosed herein, are described briefly as follows.

One form of the present invention is rewritable computer storage including video data and a command set. The video data is indicative of video information. The command set includes one or more commands for controlling a standard operation of the computer device.

A second form of the present invention is a method of operating a computer device during an interaction of the computer device and a rewritable computer storage including a command set of one or more commands. First, the command set is located on The removable rewritable computer storage. Second, an activation condition and executable status is ascertained for each command within the command set. Third, each executable command is executed upon an recognition of an associated activation condition. Finally, the results of an execution of each command is written to The removable rewritable computer storage.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates a plan view of one embodiment of a rewritable computer storage in accordance with the present invention;

FIG. 2 illustrates a block diagram of a computer device interacting with the FIG. 1 rewritable computer storage;

FIG. 3 illustrates one embodiment of a COPY FROM DEVICE TO DISK command of the present invention;

FIG. 4 illustrates one embodiment of a PLAY-ON command of the present invention;

FIG. 5 illustrates one embodiment of a EJECTION INDICATOR command of the present invention;

FIG. 6 illustrates one embodiment of a BROWSE command of the present invention; and

FIG. 7 illustrates a flowchart representative of a command set execution method of the present invention.

### DETAILED DESCRIPTION OF THE INVENTION

The present invention is directed to a control of standard operation of a computer device by a rewritable computer storage. The form of a rewritable computer storage of the present invention is without limit. Examples of a rewritable computer storage include, but are not limited to, a Compact Disc-Rewritable, a Digital Video Disc-Rewritable (“DVD-RW”, “DVD+RW”), flash memory, and removable hard disks (e.g., with a PMCIA interface). The form of a computer device of the present invention is also without limit. Examples of a computer device include, but are not limited to, a compact disc player, a digital video disc player (“DVD player”), portable devices (e.g., hard disked based audiovisual players), solid-state audio players, personal computers, and set-top boxes.

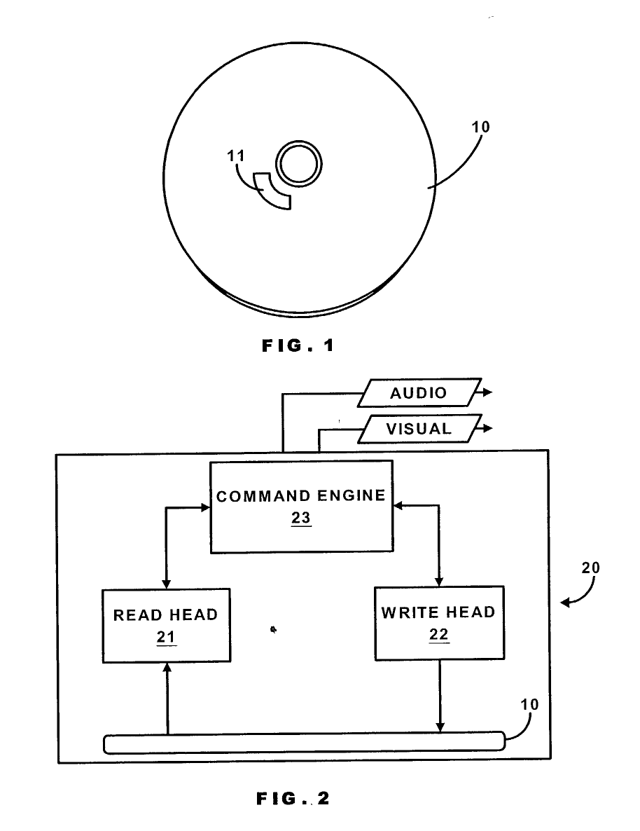

FIG. 1 illustrates a removable rewritable computer storage of the present invention in the form of a DVD+RW 10 and FIG. 2 illustrates a computer device of the present invention in the form of a DVD player 20. DVD+RW 10 includes digital data in the form of conventional video data (not shown) indicative of audio/visual information (e.g., a song, a movie, etc.). DVD+RW 10 further includes conventional commands (not shown) for locating the video data on DVD+RW 10, and a novel and unique command set 11 including one or more commands for controlling a standard operation of the DVD player 20. Examples of the standard operation of the DVD player 20 include, but are not limited to, a reading of the video data, a writing of the video data, an audio communication AUDIO of the video data to a user of DVD player 20, and a visual communication VISUAL of the video data to a user of DVD player 20.

In one embodiment, each command of the command set 11 includes an activation field, a function field, any necessary function arguments, a status field, and a result field. The activation field specifies an activation condition upon which a command is to be executed. A first activation condition is an insertion of DVD+RW 10 within DVD player 20. A second activation condition is a specified period of time after insertion of DVD+RW 10 within DVD player 20. A third activation condition is an occurrence of a specified device event. A fourth activation condition is an ejection of the DVD+RW 10 from the DVD player 20. Those having ordinary skill in the art will appreciate various additional activation conditions.

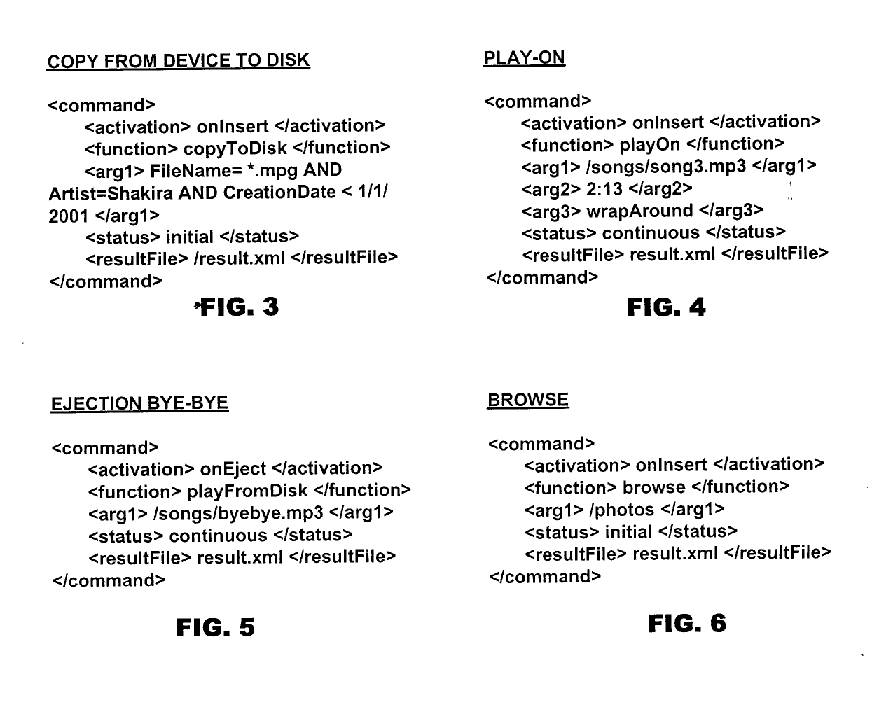

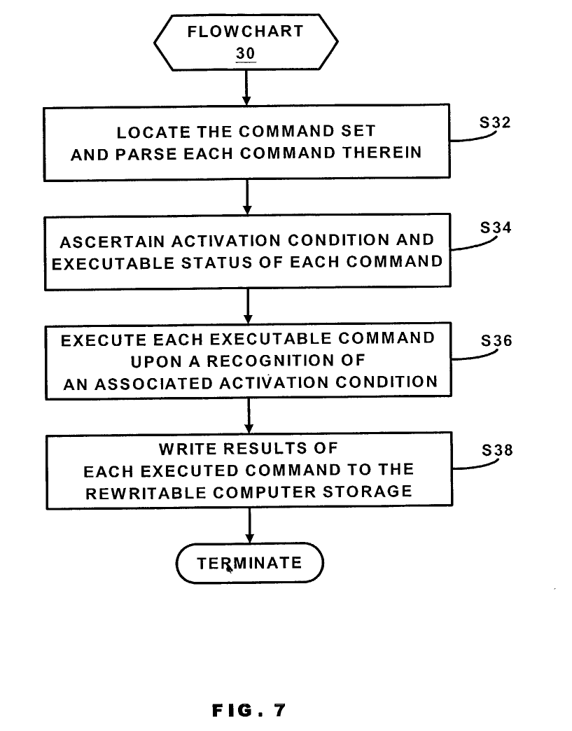

The function field specifies the type of command that is to be executed. Each function argument specifies a specific action associated with the function command. The status field specifies an executable status of the command. An “initial” indicator represents the command is to be executed only upon an initial recognition of an associated activation condition. A “continuous” indicator represents the command is to be executed upon each recognition of an associated activation condition. A “complete” indicator represents the command in no longer executable. An “error” indicator represents an error related to the command. Those having ordinary skill in the art will appreciate various additional status indicators. The result field contains results from one or more executions of the command. FIGS. 3-6 illustrate four (4) exemplary single commands for the command set 11. From the following description, those having ordinary skill in the art will appreciate a composite construction of a command consisting of multiple commands, particularly in a recursive manner.

FIG. 3 illustrates a COPY FROM DEVICE TO DISK command in an .xml format. The activation field specifies the COPY FROM DEVICE TO DISK command should be executed upon insertion of the DVD+RW 10 within the DVD player 20. The function field and function argument collectively specify a copying of all *=.mpg files by Shakira dated prior to Jan. 1, 2001 onto the DVD+RW 10. The status field specifies an initial executable status of the COPY FROM DEVICE TO DISK command. The results field specifies the result file for storing results from the single execution of the COPY FROM DEVICE TO DISK command.

FIG. 4 illustrates a PLAY-ON command in an .xml format. The activation field specifies the PLAY-ON command should be executed upon insertion of the DVD+RW 10 within the DVD player 20. The function field and functional arguments collectively specify a playing of a song3.mp3 at a 2:13 position in a wraparound manner. The status field specifies a continuous executable status of the PLAY-ON command. The results field specifies the result file for storing results from an execution of the PLAY-ON command. In this case, the results indicates a closing position in a song being played upon an ejection of the DVD+RW 10 from the DVD player 20 to thereby update the functional arguments to reflect the closing position in the song whereby a subsequent execution of the PLAY-ON command start at the closing position.

FIG. 5 illustrates an EJECTION BYE-BYE command in an .xml format. The activation field specifies the EJECTION BYE-BYE command should be executed upon an ejection of the DVD+RW 10 from the DVD player 20. The function field and functional arguments collectively specify a playing of a byebye.mp3 song. The status field specifies a continuous executable status of the EJECTION BYE-BYE command. The results field specifies the result file for storing results from an execution of the EJECTION BYE-BYE command.

FIG. 6 illustrates a BROWSE command in an .xml format. The activation field specifies the BROWSE command should be executed upon an insertion of the DVD+RW 10 within the DVD player 20. The function field and functional arguments collectively specify a browsing of a photos folder. The status field specifies an initial executable status of the BROWSE command. The results field specifies the result file for storing results from an execution of the BROWSE command.

Referring to FIG. 2, DVD player 20 includes numerous conventional components that are not directly relevant to an understanding of the present invention and are therefore not illustrated. One skilled in the art will recognize such conventional components upon an understanding of the subsequent description herein of the illustrated components of DVD player 20, which include a conventional read head 21, a conventional write head 22, and a new and unique command engine 23 consisting of hardware, software or a combination thereof. Upon a conventional detection of an insertion of DVD+RW 10 within DVD player 20 and prior to an ejection of DVD+RW 10 from DVD player 20, the command engine 23 implements a command set execution method of the present invention. In one embodiment, the command engine 24 implements the command set execution method of the present invention in response to a conventional password verification of the DVD+RW 10.

FIG. 3 illustrates a flowchart 30 representative of the command set execution method of the present invention. During a stage S32 of the flowchart 30, the command engine 23 utilizes the read head 21 to locate the command set 11 on the DVD+RW 10 whereby the command engine 23 conventionally parses each command within the located command set 11. In one embodiment, the command engine 23 employs conventional techniques for identifying a location of the command set 11 on DVD+RW 10, and thereafter directs the read head 21 to the command set 11. In a second embodiment, the command engine 23 directs the read head 21 to a known location of command set 11 on DVD+RW 10. In a third embodiment, the command engine 23 parses the commands that are deemed valid in view of a conventional policy certification of the command.

During a stage S34 of the flowchart 30, the command engine 23 ascertains the activation condition and executable status of each command within the command set 11. In one embodiment, the command engine 23 reads the activation field and the status field of each command. During a stage S36 of the flowchart 30, the command engine 21 executes an executable command upon recognition of an associated activation condition. During a stage S38 of the flowchart 30, the command engine 23 utilizes the write head 22 to write results of an executed command to DVD+RW 10. In one embodiment, the command engine 23 write results of an executed command to the results field of the command and any other corresponding files. It is to be appreciated by those having ordinary skill in the art that the command engine 23 can implement stages S34-S38 in a concurrent manner, a discrete manner or a mixture thereof for multiple commands within the command set 11.

While the embodiments of the present invention disclosed herein are presently considered to be preferred, various changes and modifications can be made without departing from the spirit and scope of the present invention. The scope of the present invention is indicated in the appended claims, and all changes that come within the meaning and range of equivalents are intended to be embraced therein.

What is claimed is:

1. A removable rewritable computer storage, comprising:
digital data indicative of information; and
a command set for controlling a standard operation of a computer device interacting with said rewritable computer storage.

2. The removable rewritable computer storage of claim 1, wherein the standard operation includes a reading of the digital data by said computer device.

3. The removable rewritable computer storage of claim 1, wherein the standard operation includes a writing of the digital data to said rewritable computer storage by said computer device.

4. The removable rewritable computer storage of claim 1, wherein the standard operation includes an audio communication of the digital data by said computer device.

5. The removable rewritable computer storage of claim 1, wherein the standard operation includes a visual communication of the digital data by said computer device.

6. The removable rewritable computer storage of claim 1, wherein said command set includes a command having an activation field, a function field, a status field and a results field.

7. A method of operating a computer device during an interaction of the computer device and a removable rewritable computer storage including a command set of one or more commands, said method comprising:
locating the command set on the removable rewritable computer storage; and
ascertaining an activation condition of a first command.

8. The method of claim 7, further comprising:
executing the first command in response to a recognition of the activation condition.

9. The method of claim 8, further comprising:
writing the results of the execution of the first command to the removable rewritable computer storage.

10. A method of operating a computer device during an interaction of the computer device and a removable rewritable computer storage including a command set of one or more commands, said method comprising:
parsing a first command to identify an activation field, a function field, a status field and a results field; and
reading the activation field to determine an activation condition of the first command.

11. The method of claim 10, further comprising:
reading the function field to determine a function of the command.

12. The method of claim 10, further comprising:
reading the status field to determine an executable status of the command.

13. The method of claim 10, further comprising:
writing a result of an execution of the command to the results field.
